(19) United States
(12) Patent Application Publication
(10) Pub. No.: US 2019/0259019 A1
(43) Pub. Date: Aug. 22, 2019

(54) Mobile Technology Application for Collection and Payment of Bills, Bank Slip and Other Debts

(71) Applicants: Edilson Hiluey, Vila Hamburguesa (BR); Celso Shiguer Kunimura, Cotia (BR); Marco Antonio Dos Santos, Santana Do Parnaiba (BR)

(72) Inventors: Edilson Hiluey, Vila Hamburguesa (BR); Celso Shiguer Kunimura, Cotia (BR); Marco Antonio Dos Santos, Santana Do Parnaiba (BR)

(21) Appl. No.: 16/348,351

(22) PCT Filed: Aug. 8, 2017
(86) PCT No.: PCT/IB2017/054846

§ 371 Date: May 8, 2019

(30) Foreign Application Priority Data
Aug. 11, 2016 (BR) BR102016026123-6

(51) Int. Cl. G06Q 20/32; G06Q 20/04; G06Q 20/06; G06Q 20/10; G06Q 20/36

(52) U.S. Cl. CPC G06Q 20/3223; G06Q 20/0453; G06Q 20/3672; G06Q 20/102; G06Q 20/0658

(57) ABSTRACT

For forwarding, receipt, storage and tracking of electronic information in safe and controlled environment in real time continuously updated by the user through an application APP, in communication with all kinds of Companies and Business producing or providing Products and/or Services (Companies). The communication will be monitored through a Control and Management Center (CMC), integrated with a dedicated Software, for Users to submit information related to payments of their bills and make payments, with strict and complete tracking, without errors and strict confidentiality of this information. Thus, the processing of any data, documents, slips, payments etc. is established by the communication between the Control and Management Center (CMC) and the APP application.

This descriptive report refers to the Application for Patent of Invention for a technology and methodology to operate as Payment of Bills by means of bank slip and other collection methods, among all the kind of Business and Companies providing or supplying Products and/or Services (Companies) to their Customers, the purchasers of those Products and/or Services (Users), such as consumption bills and other purchases made of any kind, including e-commerce, in any currency, national, Brazilian reais [Translator's Note: Brazilian currency real, plural reais] or other countries, also crypt currency (virtual currency, for instance, Bitcoins, etc.) for payment electronically directly by “Mobile Technology Application for Collection and Payment of Bills, Bank Slip and Debts (“APP”).

The technology centralizes all the collections and bills of one single User (single CPF [Individual Taxpayer ID Number]) to be paid by means of APP, directly to the bank preferred thereby, that is, the User in one single operation, APP performs the payment of one or more collection from any company using the methods as “Bank Slip”. In order to perform the payment of bills/slips, User records the Bank, Branch and number of Bank Account in the very APP, thus he/she is allowed to use this payment method in the bank account, or use the payment option by Credit or Debit Card, or by topping up the APP, wherein User should control and make payments of the bills/slips thereof and transfer values to other Users records in APP. The application shall operate also as “Digital Answering Machine (DAM) as it sends and makes the communication by means of text messages between Companies and respective Users, informing the coining maturity dates and payment advice on the maturity dates in the account linked to the recorded CPF [Individual Taxpayer ID Number]. The technology allows the communication between users, enabling sending the collection by other record by the APP. If the person is not recorded, user should send the collection by email from the application. Regarding slips from third parties, CPF [Individual Taxpayer ID Number] of bearer of collection is recorded for payments and control. For bills in arrears, the APP prepare automatically all the calculation and updating of values, as well as any penalty, interest and other costs arising thereon, all according to the parameters previously defined by Companies.

### STATE OF THE ART

Technological control center receives from Companies collection information (slips and consumption bills, etc.) which are forwarded to the Users by the Companies issuing those collection bills, for instance: Electric power, telephone, paid TV services, internet, condominium charges, school, credit card, medical care plan, insurances, any store product and services carried out in Internet (e-commerce), etc. The payment information is stored in dedicated Software, making up a database, to be transmitted to Application of Mobile Telephones, for payment of that collection in the very APP, in total control, confidentiality and safety, with proper tracking and confirmation of receipt, with no possible failure in information processing.

Currently, the use by Users is unquestionable, widely of Mobile Devices (mobile telephones, etc.) for several activities, who are familiar with the practicality, speed and other features of electronic technologies, as well as the easy way and total availability of the mobile devices for people in general, who, consequently, adhere naturally to exchange—forwarding and receipt—of information by mobile devices.

### PURPOSE OF PATENT

Such APP System, by the Control and Management Center (CMC) integrated with dedicated Software, object of this Claim for Patent of Invention, aiming to provide the technology of forwarding and receipt, storage and tracking of electronic information, in safe and controlled environment, in real time continuously updated, providing to Users the forwarding of information related to the payments made of their bills, and make such payments keeping the strict and complete tracking errors-free, and strictly confidential, of their information/data/documents/slips/payments, etc. and other measures interacting with APP to minimize the routine concerns on the control and follow-up of maturities dates, any calculation, etc.

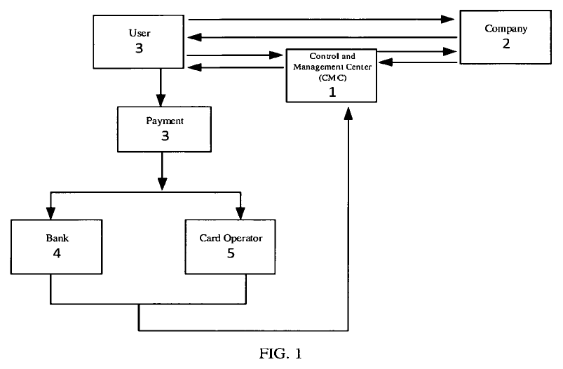

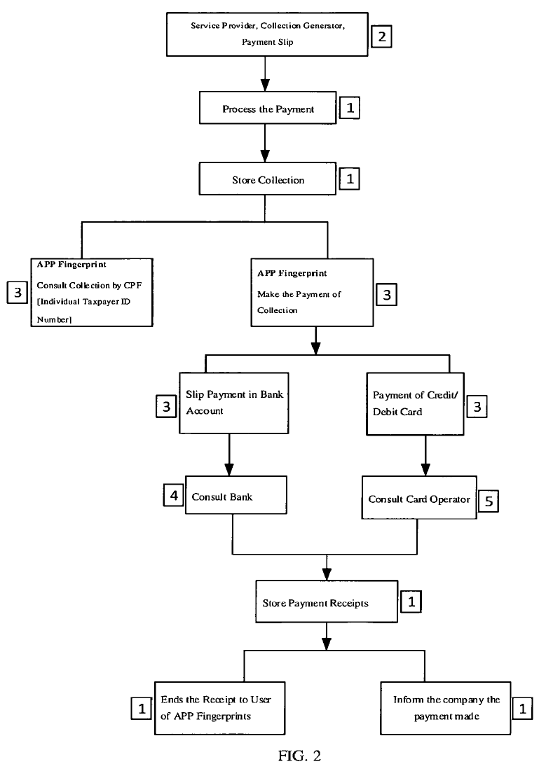

In short, the system is detailed further in FIGS. 1 and 2 as described below:

FIG. 1 shows on top part of drawing, User in initial contact with Control and Management Center (CMC) to forward by the Mobile phone the information/data to be recorded and stored in dedicated Software, thus making up his own Database. Such information shall be send to User after the proper processing.

FIG. 2 details by means of arrows, the process, including the validation and receipt of information and proper feedback of data in system.

According to drawing of FIG. 1, COMMUNICATION CONTROL CENTER OF MOBILE TELEPHONY WITH SIMULTANEOUS MANAGEMENT SYSTEM, SYNCHRONIZED IN REAL TIME THE INFORMATION STORED IN DATA BASE, RECEIVED AS FORWARDED BY USER”, purpose of this Claim of Patent is established from the Control and Management Center (CMC) in configuration of Server and Network of computers, integrating the dedicated Software to make up the database with data provided by each Company, which send them to their Users by Control and management Center (CMC), information/collection data of their interest, such as data of propaganda and marketing, collection of monthly fees (slips), mailing, as any other information related to the business thereof, or personal correspondence and similar.

Such information is properly processed and formatted, generating electronic documents in database of Control and Management Center (CMC), which should be accessed by Users at any time, or place where they are, simply using the mobile phone, or other mobile device of communication.

Control and management Center CMC) based on the variable information available in Database, after generating the proper electronic documents, arrange the forwarding to Users (indicated by Company), of those Variable and Fixed Data, according to the proposed system, as shown in FIG. 1.

Therefore, as shown in FIG. 1, Variable and Fixed Data of User is sent first to the systems operated by Control and Management Center (CMC).

As the arrows in drawing show, also by means of APP System, object of this Claim of Patent, from the Control and Management Center (CMC), Company forwards through the mobile phone network the data related to each User. After properly certifying the receipt of those data, the process is completed, and this return is totally controlled by software of Control and Management Center (CMC). If data is not confirmed to have been received, such data is reprocessed and feedback automatically by Control and Management Center CMC for resending and other measures.

As noted, the process meets of the Users ‘requests (also upgrading, new requests or subsequent request due to the constant feedback), by forwarding in a very controlled and synchronized manner in real time, and User should activate by himself the Control and Management Center CMC) to request copies of process or make payments by mobile phone, as well as sending and receiving text messages, contact the help desk, such as “Virtual Help Desk”, finally take all measures deemed necessary to complete the operation, also reducing the post expenses and “call center” operators.

APP system ensures the recipient receives the respective information in any time, with Control and Management Center (CMC) which shall provide, if necessary, the individual features of each user, filing and updating thereof automatically, thus increasing the efficacy on Company/user interaction providing immediate access to general information, as geographic location, etc., the perfect synchronism of communication, for instance, condominium charges, schools, hospitals, insurance companies, financing institutions, small business etc., at last, in all segments, also at personal level for each User.

Therefore, this Electronic Technology for Mobile Devices (APP) allows by simply touch of screen, in specific icons accessed from the dedicated Software programming of Control and Management Center CMC) to User to view from propaganda videos, the bills, for instance, as appointment book, with all individual details of fixed and variable data of expenses/payments/dates/etc., and the access of Users to Companies for clarifying doubts at any time, solving issued related to complaints, evidently any other issue related to this communication (process) offered by APP system. All this is carried out with total control and practicality as if the Digital Answering Machine (DAM)” was operating 24 hours, 7 days a week.

1. CONTROL CENTER FOR COMMUNICATION OF PAYMENT AND COLLECTION BY MOBIL PHONE”, where a Central Server is enabled to perform the programs developed in PHP and JAVA languages or any other language and standards to be developed in the future, connected to dedicated Software, is featured by controlling m communication equipment by means of mobile device or apparel, as the Mobile Technology Application for Collection and Payment of Bills, Slips and Debts (APP), comprising a plurality of Software modules, providing the access to Variable and Fixed Information list provided by Customers purchasing the Products and/or Service (Users) to all kinds of Companies and Business providing or supplying Products and/or Services (Companies) which are previously recorded in system, that information shall be duly processed to generate the documents to be stored in Database of that Control and Management Center (CMC).

2. SIMULTANEOUS MANAGEMENT SYSTEM, SYNCHRONIZED IN REAL TIME OF INFORMATION STORED IN DATABASE RECEIVED FROM ONE USER”, according to claim 1 above, featured by Variable and Fixed Information provided by Companies to be sent to Users by means of Mobile network of mobile phone.

3. “SIMULTANEOUS MANAGEMENT SYSTEM SYNCHRONIZED IN REAL TIME OF INFORMATION STORED IN DATABASE RECEIVED FROM ONE USER, according to claim 1, APP System comprises one Terminal—movable User Mobile Phone type, featured by the fact that Variable and Fixed Information including Image, Audio and Video” (Information), provided follow the stages described below:
a—Forwarding Information from the organization previously defined by User also by the kind of terminal will forward the information from Company, thus all and any communication send is immediately and automatically identified by each User, which shall contain all the characteristics related specifically and exclusively thereto;
b—Validation of receipt by Central Server (dedicated software) of Control and Management Center CM C) on the mentioned contact originating by Companies after forwarding the Information to User (“feedback”).
c—Storage of respective process (forwarding information) on dedicated software of Control and Management Center (CMC) with total safety, control, confidentiality, in real time;
d—Generation of image on terminal screen of User containing all information after the process of exchanged messages;
e—Generation of random number as Individual Validation Code (IVC)” for control by Users of each instruction and order sent, and immediate resending of each IVC to the very issuer User for advice and control.

4. “SIMULTANEOUS MANAGEMENT SYSTEM SYNCHRONIZED IN REAL TIME OF INFORMATION—APP” according to claim 1, featured by the accurate and reliable control of all and any fixed and variable Information sent and received between Company and each User by means of mobile telephony technology, with automatic resending, and thus successively, allowing the payment of bills in general, by means of digital Virtual Slip, in national currency, Brazilian reais or foreign currency, also crypt-currency (virtual currency, for instance, Bitcoins, etc.) all in strict compliance with provisions of applicable laws.

5. “SIMULTANEOUS MANAGEMENT SYSTEM SYNCHRONIZED IN REAL TIME OF INFORMATION—APP” according to claim 2, featured by the accurate and reliable control of all and any fixed and variable Information sent and received between Company and each User by means of mobile telephony technology, with automatic resending, and thus successively, allowing the payment of bills in general, by means of digital Virtual Slip, in national currency, Brazilian reais or foreign currency, also crypt-currency (virtual currency, for instance, Bitcoins, etc.) all in strict compliance with provisions of applicable laws.

6. “SIMULTANEOUS MANAGEMENT SYSTEM SYNCHRONIZED IN REAL TIME OF INFORMATION—APP” according to claim 3, featured by the accurate and reliable control of all and any fixed and variable Information sent and received between Company and each User by means of mobile telephony technology, with automatic resending, and thus successively, allowing the payment of bills in general, by means of digital Virtual Slip, in national currency, Brazilian reais or foreign currency, also crypt-currency (virtual currency, for instance, Bitcoins, etc.) all in strict compliance with provisions of applicable laws.
